(19) United States
(12) Patent Application Publication
(10) Pub. No.: US 2025/0158094 A1
(43) Pub. Date: May 15, 2025

(54) AIRFLOW CONTROL HOUSING

(71) Applicant: WATT FUEL CELL CORP., Mt. Pleasant (PA)

(72) Inventors: Caine M. FINNERTY, Mount Pleasant, PA (US); Paul DEWALD, Scottdale, PA (US); Mathew ISENBERG, North Canton, OH (US)

(21) Appl. No.: 18/839,854

(22) PCT Filed: Jan. 30, 2023
(86) PCT No.: PCT/US2023/011817

§ 371 Date: Aug. 20, 2024

Related U.S. Application Data
(60) Provisional application No. 63/327,428, filed on Apr. 5, 2022.

(51) Int. Cl. H01M 8/04007; B01J 19/00; F28F 9/00; H01M 8/0297; H01M 8/04082; H01M 8/04111

(52) U.S. Cl. CPC H01M 8/04067; B01J 19/0013; F28F 9/001; H01M 8/0297; H01M 8/04111; H01M 8/04201; B01J 2219/00094; B01J 2219/0015

(57) ABSTRACT

An apparatus with at least two thermal zones of different temperatures, each thermally isolated from the other. A stream of ambient air is used to isolate the two zones. A housing can have a dual wall construction defining an air conduit between the two walls, above, below and/or around the sides. An exothermic device can be mounted within the housing. In operation, a blower within the housing draws air into the air conduit at the rear of the housing. The intake air flows around the housing, then into the exothermic device. A cool zone can be located within the housing, upstream from the blower, kept cool by the flow of ambient air. A hot zone can exist downstream from the blower. A third zone of intermediate temperature can be located downstream from the blower, upstream from the device. The exothermic device can be physically isolated from the cool zone by the blower and an insulated wall on which the blower can be mounted. The ambient air fed to the hot zone can be the source of oxygen for the exothermic device.

The invention relates to housings, and more particularly to the construction of a housing enclosing an exothermic mechanism, such as a fuel cell, net exothermic device, or fuel reformer.

Exothermic mechanisms, such as catalytic oxidation, combustion or reformation devices, are often controlled with various electronic systems. It can be important to shield the electronics from the heat given off by these mechanisms. It can also be important to isolate the heat given off from these mechanisms so that these mechanisms can be more conveniently integrated into their surrounding environment. For example, internal combustion engines, fuel cells and fuel reformers produce a considerable amount of heat. This can present a difficulty when trying to locate these mechanisms in close proximity to individuals, or within a habitat or other structure. This can also present difficulties when trying to provide a compact device with a compact housing, wherein portions of the mechanism, such as electronics must be close, proximately, yet isolated thermally.

The constructions of conventional heat producing mechanisms, such as internal combustion engines, fuel cells and fuel reformers have presented additional difficulties, which make it difficult to integrate these mechanisms into an inhabited environment.

Accordingly, it is desirable to provide improved structures for a heat producing mechanisms that overcomes drawbacks of the prior art.

### SUMMARY OF THE INVENTION

Generally speaking, in accordance with the invention, an apparatus has at least two thermal zones at different temperatures, each thermally isolated from the other. Each zone can have sub zones at intermediate temperatures between the hot and cool zones. An airstream of ambient air from an air intake of the apparatus can be used to isolate the zones. In one embodiment of the invention, the airstream passes over the outside of the apparatus to thermally isolate the outside surface of the apparatus from the inside. In another embodiment of the invention, the airstream of the air intake is used to thermally isolate at least two internal zones of the apparatus. In still another embodiment of the invention, both the outside surface and internal zones are thermally isolated by the flow of air through and/or around the apparatus.

In one embodiment of the invention, the apparatus includes a heat producing mechanism, such as an internal combustion engine, fuel reformer or a fuel cell. An air stream of an air intake for the oxygen source of the heat producing mechanism is used to help keep thermal zones thermally isolated from each other. For example, a stream of ambient air can be blown or drawn over various components of the mechanism, such as electronic components, to keep those components cool. The intake air stream can also thermally isolate the outside surface of the apparatus from the heat produced therein. This can be accomplished by drawing the intake air within the outside surface of the apparatus, but around the outside of the exothermic elements. This airstream can also be blown or drawn over any electronics or other elements that need to be kept cool. This air can then flow into the exothermic elements to serve as the source of oxygen for any chemical reactions therein.

In one embodiment of the invention, the exothermic mechanism can be enclosed within a double wall or multi-wall enclosure of a housing for the mechanism. The interior space between the outer and inner walls can act as an air intake conduit, which can function as a tube-within-a-tube construction. An array of fins can extend across the gap between the outer and inner walls, to transform this construction into an assembly of air intake tubes around the entire length of the exothermic mechanism. This intake airstream can also be drawn or blown through an interior cool section or sections of the mechanism and then fed into the exothermic section of the mechanism as the source of air/oxygen. Any hot exhaust can be fed directly outside the housing and can be piped away to a convenient exhaust location. Accordingly, if the air intake is on a rear end of the device, the cool ambient air can be drawn in and drawn around the entire top and/or bottom and/or sides of the device, including the cool portions of the interior thereof. The intake air can then be fed into the exothermic hot section and the exhaust can be emitted out from the rear end. The intake and exhaust can be side-by-side or concentric. For example, the intake can surround the exhaust.

In one embodiment of the invention, a housing for the device has a double wall construction, with both an inlet and an outlet at the rear end. The heat generating mechanisms can be mounted on a platform and can be slid in and out of a front end of the housing. Accordingly, if the apparatus is used to produce electricity, the apparatus can remain independently connected to an installation, such as a home, R/V, office, ant the like, and the core stack/BOP and electronics can be slid out of the housing and either serviced or replaced. A blower can be positioned at the front end. The blower can draw cooling air into the rear end of the housing, around the length of the device through the double wall air passageway, and into a the front end of the housing. A front interior zone in the front end of the housing can serve as a cool zone, where electronics and other elements that need to be kept cool can be mounted. After passing over the outside of the exothermic device and through the cool zone, the stream of intake air can be blown into the exothermic elements and then exhausted outside the device. An additional cool zone can be provided upstream, or preferably downstream from the main blower, to house flow control blowers that control the precise airflow into the exothermic elements and help control the exothermic reactions therein. In preferred embodiments of the invention, such additional electronically controlled blowers are located in this flow control cool zone, and the flow of air into this zone keeps this flow control zone cool.

By adjusting the dimensions of the double wall air conduit, the air flow through the air intake conduit can have a high velocity and provide a high-efficiency cooling system to insulate the exothermic elements from the outside of the device. In this manner, the velocity of the incoming air through the housing conduit, can be kept high enough to help insure that preheating of the intake air is sufficiently low and cooling of the external surfaces is maximized. Therefore, the device can be located in close proximity to individuals in the vicinity of the device. The outside surface of the device need not become too hot. Also, the device can be relatively compact. Any electronics or other elements for the device can be kept cool in a cool zone, without requiring large physical separations.

Other advantages and objects of the invention will be apparent from the drawings and descriptions to follow.

### BRIEF DESCRIPTION OF THE DRAWINGS

The following drawings are presented for illustration only, and should not be considered to limit the scope of the invention. The drawings are proportional, but other proportions are acceptable, within the spirit and scope of the invention.

FIG. 1 is a perspective view of a fuel cell, in accordance with a preferred embodiment of the invention;

FIG. 2 is a side cross-sectional view of the fuel cell of FIG. 1;

FIG. 3 is a cross-sectional, exploded view of the fuel cell of FIG. 1;

FIG. 4 is an end cross-sectional view of a front portion of the fuel cell of FIG. 1;

FIG. 5 is an end cross-sectional view of a rear portion of the fuel cell of FIG. 1; and

FIG. 6 is a schematic cross-sectional view of a fuel cell in accordance with a preferred embodiment of the invention.

### DETAILED DESCRIPTION OF THE PREFERRED EMBODIMENTS

The present disclosure may be understood more readily by reference to the following detailed description of the disclosure, taken in connection with the accompanying figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The invention relates to exothermic mechanisms. Examples include a fuel-consuming apparatus, a fuel-processing apparatus, an exothermic apparatus, or other heat generating apparatus. These terms can encompass any exothermic apparatus based on any kind of fuel, including the apparatuses described in Ser. No. 17/267,095, filed Feb. 9, 2021, as well as in U.S. Pat. Nos. 9,627,700 and 9,627,701. The contents of this application and these patents are incorporated herein by reference. Heat generating and/or exothermic apparatuses include electric generators, fuel reformers, fuel cell stacks and systems, and the like. The expression fuel, shall be understood to include both liquid fuels and gaseous fuels, including vaporized liquid fuels.

As used herein, the term fuel cell stack can include a plurality of assembled fuel cells. Each fuel cell may generate electricity, in the form of direct current from electro-chemical reactions taking place therein. The individual fuel cells can be combined into a stack and the balance-of-plant (BOP) components can include various systems and structures for the generation of electric power, including fuel reformers, chemical reactors, gaskets, pumps, sensors, vaporizers, heat exchangers, blowers, switches, relays, thermistor's, thermocouples, conduits, control electronics, catalytic oxidizers, combustors and the like.

Examples of heat generating apparatuses in accordance with the invention include those described in U.S. Pat. Nos. 9,627,700 and 9,627,701. The entire contents of these patents are incorporated herein by reference. Fuel reformers in accordance with the invention can be configured to supply reformate, such as hydrogen-rich reformate to a fuel cell stack. The fuel cell stack may operate at a relatively high temperature for maximizing electric power generation. Furthermore, a sufficient amount of airflow can be required for the fuel cell stack and/or the BOP components. A portion of or all the air flow may be mixed with the fuel to provide, for example, a fuel-air mixture suitable for the production of a hydrogen rich reformate. The airflow can also be used for the purpose of diluting the fuel, to control the intensity of the chemical reactions, or maintain operation under certain explosive limits for combustible fuels. In addition, other electronic components of the fuel cell system can serve as heat generation sources, that are required to be cooled down for proper operation.

Accordingly, there may exist various thermal zones and thermal sub-zones of those zones, that need to be maintained at different temperatures, depending on the types and functions of the individual components therein.

As used herein, the terms hot zone and cold or cool zone are relative in nature. For example, a cold or cool zone could be well above room temperature, but below the temperature of the hot zone. In addition, the hot zone and the cold zone can include various sub-zones of different relative temperatures.

A heat generating apparatus in accordance with preferred embodiments of the invention can include a low temperature thermal zone and a high temperature thermal zone. A heat insulating wall and/or an air blower can be located at the interface of the two zones. The low temperature (cool) thermal zone can be in fluid communication with an air inlet, wherein a stream of ambient air is drawn into the apparatus. The high temperature (hot) thermal zone includes a heat generating device, such as a fuel reformer, fuel cell, catalytic oxidizer, combustor, internal combustion engine and the like. The two zones can be separated with a heat insulating wall. An air blower can be present at the interface of the two zones. The air blower can draw ambient air into the low temperature zone and maintain the low temperature of the cool zone by the constant flow of ambient air. The blower can then blow this air into the hot zone, as required for proper operation of the exothermic reaction therein.

The heat generating apparatus can be constructed with a heat generating device mounted on a platform, with a housing surrounding the platform. The housing can have a two-layer dual (or multilayer) wall, with an air passageway therebetween. The inner and outer layers of the two layer, or multilayer wall can be segmented by a plurality of fins, running the length of the walls, to create a plurality of air passageway tube structures along the length of the two-layer wall and increase the efficiency of air flow.

An ambient air inlet can be present at a rear end of the housing and an air blower can be present at a front end of the housing. Thus, the air can be sucked into the inlet and flows through the housing, around the outside of the entire apparatus to the front region thereof. This can create a cool zone around the outside of the apparatus. The rear end can also contain a cool zone, where the ambient air is drawn in. The front end can also contain a cool zone, as the ambient air flows from the air passageway to the front end of the housing. Consequently, a cool zone can be air-flow isolated from the hot zone, across the air blower. Thus, components that need to be cool, such as electronic components, can be mounted in one of the cool zones (front, side or rear) and the outer surface of the apparatus can be kept at a relatively cool temperature.

In one embodiment of the invention, the apparatus includes a fuel cell system, with one or more fuel-processing components. These one or more fuel-processing components can include one or more balance-of-plant (BOP) components configured to supply reformate fuel to a fuel cell stack. The fuel cell stack can be configured to generate electric power based on the reformate provided from the one or more BOP components. The exothermic components can be located in the hot zone, and any components they need to be kept cool, such as electronically controlled blowers that control of air to the exothermic components can be located in and draw air from the cool zone.

In one embodiment of the invention, the housing/blower assembly can include a flow switch unit, configured to be shut off when air flow does not meet a preset requirement. Air flow can be measured by a flow switch unit. Air flow at the blower(s) can also be adjusted to maintain performance of the apparatus, when air flow amounts meet preset requirements. In one embodiment of the invention, an air flow switch unit can include a flat upper or differential pressure switch. A blower that operates at different speeds can be employed to adjust the flow of air as needed.

A housing for the apparatus can include a thermal separation wall, formed of thermal insulation material, to separate the hot and cool zones. In addition, the cool zone or the hot zone can be separated into different sub-zones, maintained at different temperatures.

In one embodiment of the invention, a fuel cell system and one or more fuel-processing components can include one or more BOP components configured to supply reformate to a fuel cell stack. The fuel cell stack can be configured to generate electric power based on the reformate provided from the one or more BOP components. The fuel cell stack can be located in a first hot sub-zone and the BOP components can be provided in a second hot sub-zone at a temperature cooler than the first hot sub-zone.

In one embodiment of the invention, the air inlet port can be positioned at the rear end of the housing and configured to draw ambient air into the cool zone. The hot zone can include a hot zone exhaust, exhausting hot gases created by the exothermic reactions therein. The hot zone exhaust can also be located at the rear of the housing. In one embodiment of the invention, the exhaust and the inlet are concentric. In one embodiment of the invention, the exhaust port is surrounded by the air inlet port.

In operation, the blower can draw air in through the inlet, into a rear end interior space enclosed by the housing, around the outside of the housing, into a front end interior zone of the housing. The blower can then blow the air directly into the hot zone, or indirectly into the hot zone, such as into a fuel reformation or combustion apparatus, after first passing through a cool zone. Hot exhaust gases exit through a hot zone exhaust port. The electronic components can be located in the cool zones and the fuel processing components can be located in the hot zones of the apparatus, with the cool zones in fluid communication with the ambient intake air inlet, and the hot zone in fluid communication with the exhaust port. In one embodiment of the invention, the hot zone can be fully enclosed at the front, sides and/or rear, by a cool zone, except that the exhaust port.

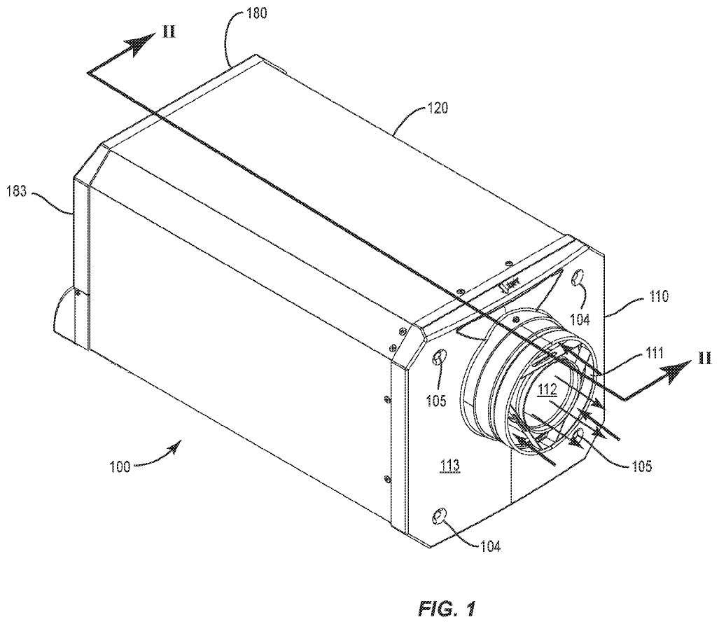

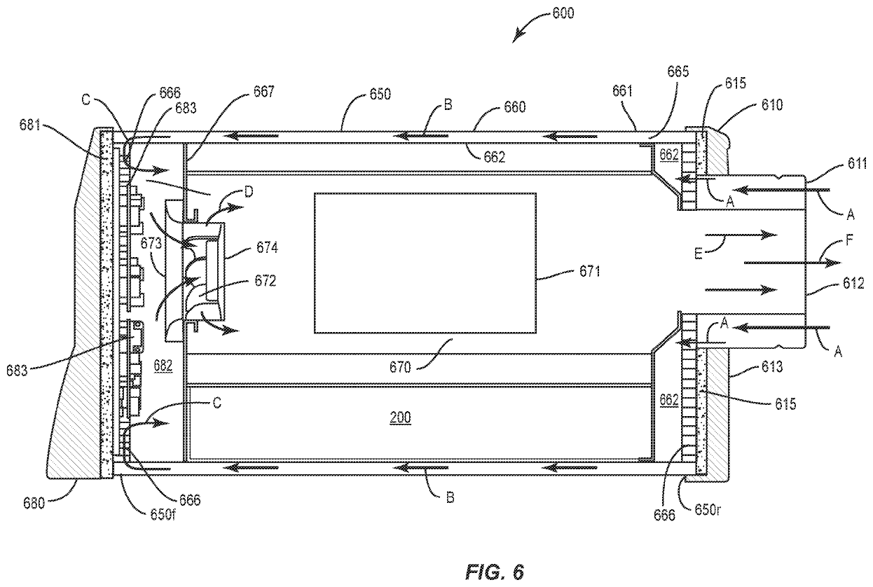

One preferred embodiment of a fuel cell device constructed in accordance with a preferred embodiment of the invention is shown generally in FIG. 1, as a fuel cell system 100. A simplified schematic view of a fuel cell system similar to fuel cell system 100 is shown generally in FIG. 6 as fuel cell system 600

Fuel cell system 600 includes a rear end 610, a midsection 650, and a front end 680. Midsection 650 extends from a midsection rear 650r to a midsection front 650f thereof. Midsection rear 650r of midsection 650 is located at rear end 610 of fuel cell 600. Midsection front 650f of midsection 650 is located at front end 680 of fuel cell 600. Fuel cell rear end 610 includes an inlet 611 concentric with an outlet 612, formed through a rear cap 613. Midsection 650 includes a housing cover 660 around a hot zone 670, with an exothermic fuel cell stack 671 mounted therein. Fuel cell stack 671 includes a fuel reformer portion, an anode portion, and a cathode portion for converting fuel into electricity.

A blower 672 is mounted at the front side of hot zone 670 to draw air into fuel cell system 600. An electronics control assembly 683 is mounted in a cool zone 682 at the front end of housing cover 660. Additional electronic controls can be located in a flow control zone 200, which can receive a portion of intake air downstream or optionally, upstream from blower 672. Flow control zone can be considered a cool sub-zone or a hot sub-zone, as it can be warmer than cool zone 682, but cooler than hot zone 670. Fuel cell 671, blower 672, and electronics 683 (and optional flow control zone 200) can all be mounted together as a unit, which can be slid into and out of front end 680 of housing cover 660.

Housing cover 660 is formed with an outer wall 661 and an inner wall 662. An interior conduit 665 is formed between outer wall 661 and inner wall 662. An array of fins 666 extend from an inner surface of outer wall 661, into interior conduit 665, to inner wall 662 and form an array of tubular conduits along the inner surface of outer wall 661.

Inner wall 662 is shorter than outer wall 661. Therefore, interior conduit 665 is exposed at rear end 650r and front end 650f of midsection 650. A gasket 615 is present around the outside rim of an inner surface of rear cap 613. Rear end 650r of midsection 650 is pressed into gasket 615. Because inner wall 662 of midsection 650 is shorter than outer wall 661 and fins 666, interior conduit 665 is accessible at rear end 650r of midsection 650. Similarly, a gasket 681 is present around the outside rim of an inner surface of front end 680. Thus, interior conduit 665 is also accessible at front end 650f. Consequently, an interior space is created inside rear cap 613 and front end 680. These interior spaces are in fluid communication with interior conduit 665.

Air inlet 611 is in fluid communication with the interior defined by rear cap 613/rear end 610. However, outlet 612 is sealed from the interior of rear end 610. Therefore, any air entering inlet 611 enters the interior of rear end 610, which is in fluid communication with interior conduit 665 at rear end 650r of midsection 650. Interior conduit 665 is in fluid communication with a front interior 682 of front end 680 at front end 650f of midsection 650. An inlet end 673 of blower 672 is in fluid communication with interior 682 of frontend 680 and an outlet end 674 of blower 672 is in direct or indirect fluid communication with hot zone 670 and fuel cell 671. Thus, as blower 672 operates, it draws air into inlet 611 in the direction of an arrow A, along inner conduit 665 in the direction of an arrow B, and then into front interior 682, in the direction of an arrow C. An assembly of electronics 683 are mounted in front interior 682. Thus, cool intake air blows over electronics 683 prior to directly or indirectly entering hot zone 670 and/or fuel cell 671.

By virtue of intake air flowing along the outside of fuel cell system 600 and into interior 682 of front end 680, a cool zone is formed on the outside of fuel cell 600 and at front interior 682. Therefore, the outside surface of fuel cell 600 and front interior 682, containing electronics 683 and other elements that need to be kept cool can be provided. An insulating wall 667 is provided at the rear end of cool zone 682. Blower 672 is mounted on insulating wall 667. Together, wall 667 and blower 672, as well as intake air flowing through conduit 665 help isolate the exothermic portions of fuel cell 600.

Intake air flows to and around fuel cell 671 in the direction of arrows D. In preferred embodiments of the invention, at least some of the air from blower 672 is vented to a cool zone 200 and from there, to fuel cell 671. Air enters fuel cell 671 and takes part in an exothermic reaction, producing both usable electricity that can flow out of system 600, and a hot exhaust gas stream, traveling in the direction of arrows E. The exhaust stream then exits exhaust 612 of fuel cell system 600 in the direction of arrows F. Exhaust 612 can be elongated, so as to transport hot exhaust gases to an appropriate chimney, flue or other structure. However, because exhaust 612 is concentric within intake 611, the intake air helps isolate this heat.

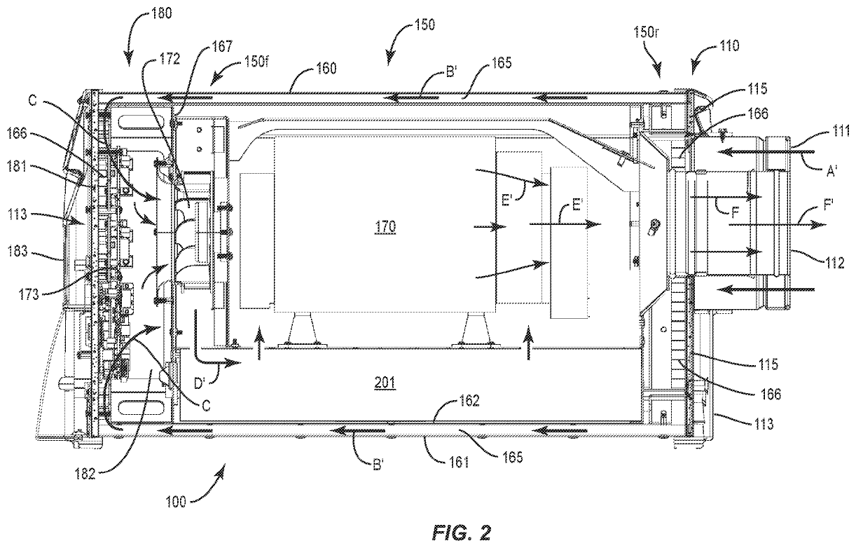

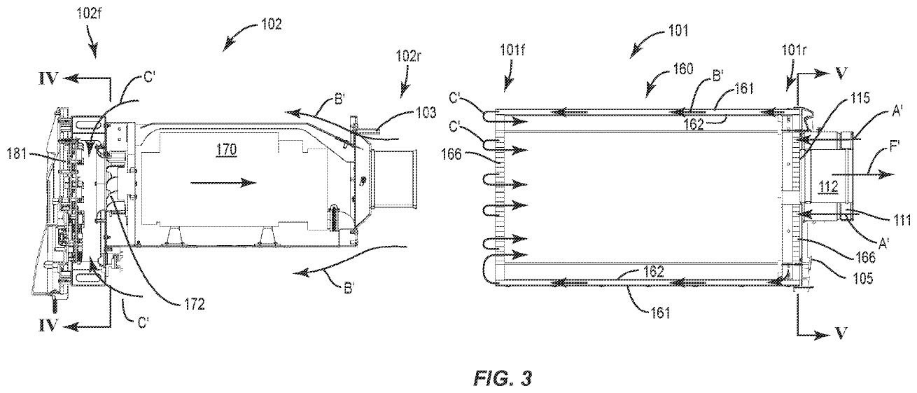

Referring again to FIG. 1, fuel cell system 100 is shown in cross-section along line II-II in FIG. 2. FIG. 3 shows fuel cell system 100 in its two main parts, a housing section 101 and a mechanism section 102. To assemble fuel cell 100, a mechanism rear end 102r of mechanism section 102 is inserted into an opening at a housing front 101f of housing 101. Mechanism rear 102r includes four threaded tubes 103. When mechanism section 102 is inserted into housing 101, threaded tubes 103 are received at corresponding bolt receiving openings 104. Four bolts 105 are inserted into tubes 103 and draw mechanism rear 102r tight against a housing rear 101r of housing 101. A mechanism front 102f is also drawn tight against a housing front 101f. A rear gasket 115 seals mechanism rear 102r against housing rear 101r. A front gasket 181 inside a front cap 183, seals front 102f against gasket 181 at housing front 101f.

Fuel cell system 100 includes a rear end 110, a midsection 150, and a front end 180. Midsection 150 extends from a midsection rear 150r to a midsection front 150f. Midsection 150r is located at rear end 110 of fuel cell system 100. Midsection 150f is located at front end 180. Fuel cell rear 110 includes an inlet 111 concentric around an outlet 112. Rear end 110 also includes a rear cap 113. Front end 180 includes front cap 183.

Midsection 150 includes a housing cover 160 around a fuel cell 170 of mechanism section 102. Fuel cell 170 includes a fuel reformer portion receiving a mixture of a fuel and an oxygen containing gas, an anode portion and a cathode portion, with wiring to draw externally usable electricity from fuel cell 170. A blower 172 is mounted on a thermal insulation wall 167. zzFuel cell 170 is located within a hot zone, on the rear side of insulation wall 167. An electronic control assembly 173 is located on a front side of insulation wall 167. Additional electronic controls can be located in another flow control cool section 201.

Housing cover 160 has a two-wall construction, with an outer wall 161 around an inner wall 162. An air conduit 165 is formed between outer wall 161 and inner wall 162. An array of fins 166 extend between an inner surface of outer wall 161, to an inner surface of inner wall 162, across conduit 165. Fins 166 form an array of tubular conduits extending from the front end to the rear end of air conduit 165.

Inner wall 162 is shorter than outer wall 161. Therefore, the array of tubular conduits of interior conduit 165 is exposed at midsection front 150f and midsection rear 150r. The rear and front ends of outer wall 161 are sealed against gaskets 115 and 181, respectively. Therefore, inlet 111 is in fluid communication with conduit 165. As air enters inlet 111, it travels along conduit 165, along the outside of midsection 150, to front end 180 of fuel cell system 100.

The front end of outer wall 161 is pressed against front gasket 181. Inner wall 162 does not reach front gasket 181. Therefore, the front end of air conduit 165 is in fluid communication with a front interior 182 defined by front cap 183 at front end 180.

An intake side of blower 172 is exposed within the rear end of front interior 182. As blower 172 operates, it blows air from front interior 182 directly or indirectly to fuel cell 170. In preferred embodiments of the invention, blower 172 directs a flow of air to flow control cool zone 201. Air from flow control zone 201 flows to fuel cell 170. The region around fuel cell 170 is a hot zone. Operating blower 172 creates a lower pressure in front interior 182. Because front interior 182 is in fluid communication with conduit 165, which in turn is in fluid communication with air inlet 111, operating blower 172 draws air into inlet 111 in the direction of arrows A′. This intake air then flows around the outside of fuel cell system 100, in the direction of arrows B′. The intake air then flows past an assembly of electronics 173 on rear cap 183, into front interior 182 in the direction of arrows C′. These air passageways are thermally insulated from fuel cell 170. Therefore, they provide a cool zone at a temperature well below that of a hot zone region surrounding fuel cell 170, to protect electronics that can be located in cooler zones 182 and 201.

Blower 172 can direct at least some of the intake air into flow control section 201 in the direction of arrows D′. From there, at least some of the air flows into fuel cell 170 and at least some of the air flows around fuel cell 170. The oxygen in the air flowing into fuel cell 170 can take part in exothermic reactions at fuel cell 170, producing a hot exhaust gas stream, traveling in the direction of arrows E′. The exhaust stream then exits exhaust 112 of fuel cell system 100, in the direction of arrows F′.

Because ambient intake air flows along the outside of housing 101 of fuel cell 100, and into front interior 182 of front end 180, a cool zone is formed around the outside of fuel cell system 100 and within front interior 182. Therefore, the outside surface of fuel cell system 100 can be maintained at an acceptable temperature. If elements, such as electronic controls, need to be kept cool, they can be mounted within front interior 182 or in flow control zone 201. It is also possible to divert some of the intake air flow, and provide other cool zones of system 100. Flow control zone 201 will typically be warmer than cool front interior 182, but cooler than the hot zone around fuel cell 170.

The thickness and a cross-sectional area of conduit 165 will affect the speed of the air flowing therein in the direction of arrow B′. Those of ordinary skill in the art will understand how to select the blowers that provides a sufficient amount of air for the fuel cell system, and to adjust the dimensions of air conduit 165, to provide air flowing at an acceptable speed for a cooling purposes, as well as without providing too much air resistance to affect total air flow into the fuel cell.

Fuel cell system can be wired to power a home, R/V or other dwelling. The overall dimensions can be relatively small, 6-24″×6-24″×12-36″, with an overall length of under 4 feet preferred, as is an overall length over 6″ preferred. Fuel lines for providing reformable fuels should also be included. If liquid fuel is to be used, a vaporizer to vaporize the liquid fuel is useful.

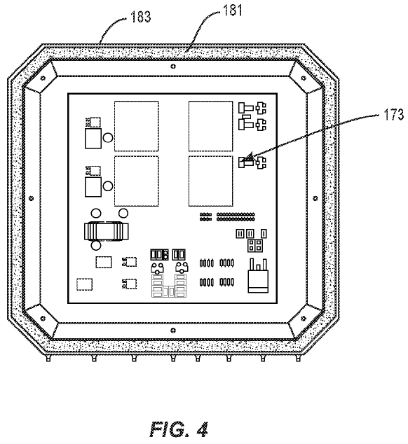

FIG. 4 is a rear end cross-sectional view of front cap 183, taken along line IV-IV of FIG. 3. As can be seen, gasket 181 is disposed around the interior edge of the front cap 183. Referring to FIG. 3, mechanism section 102 is slid into housing section 101, and front cap 183 is urged towards housing 101 to create a sealing engagement between gasket 181 and the front end of outer wall 161, but not inner wall 162, of air conduit 165. This seal at outer wall 161 only directs the airflow from conduit 165 into cool zone front interior 182. As discussed above, front interior 182 is defined by the space between front cap 183 and insulating wall 167, with blower 172 thereon. A circuit board with electronic controls 173 is mounted to the rear surface of front cap 183, and therefore positioned within the cool zone of front interior 182, where cool intake air from conduit 165 is drawn over circuit board 173 by blower 172.

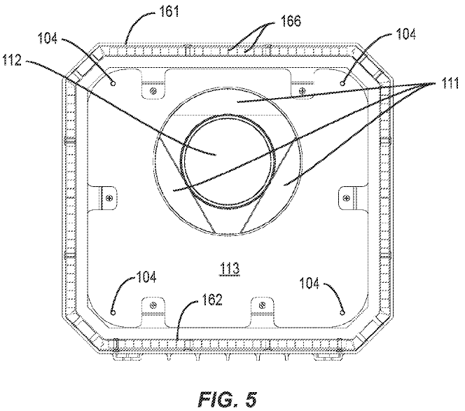

FIG. 5 is a front end cross-sectional view of rear cap 113, taken along line V-V of FIG. 3. As discussed above, rear cap 113 includes four bolt receiving holes 104, which engage bolt receiving tubes 103. As bolts 105 are drawn tight, this draws mechanism section 102 into gasket 115 (not shown in FIG. 5) in rear cap 113, to make the interior of rear cap 113 in fluid communication with inlet 111 and air conduit 165. Thus, air is sucked from blower 172, from front interior 182, from conduit 165, from the interior of rear cap 113, after passing through inlet 111. Exhaust gases from fuel cell 170 are expelled through exhaust 112.

Note that where this application has listed the steps of a method or procedure in a specific order, it may be possible, or even expedient in certain circumstances, to change the order in which some steps are performed, and it is intended that the particular steps of the method or procedure claim set forth below not be construed as being order-specific unless such order specificity is expressly stated in the claims.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

1. An apparatus having a heat producing exothermic mechanism therein, comprising:
a housing having an exterior surface and an interior surface, a front and a rear, and a length from the front to the rear;
the exothermic mechanism having a top, bottom, front, rear and sides, mounted within the housing interior;
an air intake conduit in fluid communication with a source of ambient air at an air inlet at the exterior rear of the housing, the air intake conduit in fluid communication with the exothermic mechanism, the air intake conduit constructed, arranged, and adapted to provide the air from the inlet to the exothermic mechanism, the air intake conduit located around the top, and/or bottom, and/or front, and/or rear and/or sides of the exothermic mechanism;
whereby the ambient air in the air intake conduit thermally insulates the exterior surface of the housing from the exothermic mechanism.

2. The apparatus of claim 1, wherein the housing has a two-wall construction, with an outer wall, an inner wall, and a gap therebetween, defining a wall interior conduit, and at least a portion of the air intake conduit comprises the wall interior conduit.

3. The apparatus of claim 2, and comprising fins extending along the length of the wall interior conduit from the outer wall to the inner wall, across the wall interior conduit, defining an array of airflow tubes along length of the wall interior conduit.

4. The apparatus of claim 1, wherein the rear of the housing includes an air intake port at the exterior surface and a rear interior space is defined by the housing interior surface, the rear interior space in fluid communication with and downstream from the air intake port, and wherein the air intake conduit comprises the rear interior space.

5. The apparatus of claim 1, wherein the rear of the housing comprises a rear gasket and a rear end of the array of airflow tubes is partially sealed against the rear gasket to seal the rear interior space in fluid communication with the array of airflow tubes.

6. The apparatus of claim 1, wherein the front of the housing includes a front interior space and the air intake conduit comprises the front interior space, the front interior space located upstream from the exothermic mechanism, whereby air from the front interior space flows to the exothermic mechanism.

7. The apparatus of claim 6, further comprising an interface separating the front interior space from the exothermic mechanism, and an air blower having an inlet and an outlet is located at the interface, downstream from the front interior space and upstream from the exothermic mechanism, and wherein when the air blower is operating, the air blower inlet draws in air from the front interior space and blows the air from the front interior space through the air blower outlet downstream toward the exothermic mechanism.

8. The apparatus of claim 1, wherein the blower directs the air downstream to an airflow control zone, containing electronically controlled blowers having airflow inlets drawing air in from the airflow control zone, and airflow outlets in fluid communication with the exothermic mechanism, wherein the airflow control zone is cooled by air from the air blower and is at a temperature cooler than the exothermic mechanism.

9. The apparatus of claim 6, wherein the front interior space includes a front gasket and a front end of the array of airflow tubes is partially sealed against the front gasket to seal the front interior space into fluid communication with the array of airflow tubes.

10. The apparatus of claim 6, and comprising an assembly of electronic components, wherein the electronic components are located in the front interior space, upstream from the blower.

11. The apparatus of claim 7, wherein the interface comprises a heat insulating wall and the blower is mounted on the heat insulating wall.

12. The apparatus of claim 1, wherein the housing interior comprises a cool zone and a hot zone, and the cool zone is kept cool by air from the air intake conduit and the hot zone is heated from heat from the exothermic mechanism.

13. The apparatus of claim 12, wherein electronic components are mounted within the cool zone.

14. (canceled)

15. (canceled)

16. The apparatus of claim 7, wherein the outlet of the exothermic mechanism is concentric with the air inlet.

17. An apparatus having a heat producing device constructed and arranged to perform an exothermic chemical reaction through the oxidation of a liquid or gaseous fuel, comprising:
a housing having an exterior, and an interior open space, the housing having a front end, a rear end, and length between the front end and the rear end, a front interior space at the front end, and a rear interior space at the rear end;
an air inlet at the rear end in fluid communication with the rear interior space, whereby ambient air can enter the rear interior space through the air inlet;
the exterior of the housing comprising a multi-wall conduit having at least two walls extending along the housing length, an outside surface of the conduit at the exterior of the housing and an inside surface of the conduit defining the interior space of the housing, the multi-wall conduit downstream from and in fluid communication with the rear interior space and upstream from and in fluid communication with the front interior space;
a section wall at an upstream rear end of the front interior space and an air blower on the section wall constructed, arranged, and adapted to draw air into the air inlet, through the multi-wall conduit, into the front interior space and out an outlet of the air blower;
electronic components mounted in interior open space of the housing;
the heat producing device mounted within a hot zone of the housing interior space, thermally sealed from the front interior space by the section wall and blower, downstream from the blower, and adapted to receive air directly or indirectly from the blower;
the electronic components positioned upstream from the heat producing device, wherein they can be kept cooler than the heat producing device by the airflow upstream the heat producing device;
an exhaust outlet positioned and adapted to emit an exhaust from the heat producing device to the exterior of the housing; and
whereby when the blower is operated, it draws air from the air inlet, into the front interior space, downstream into the multi-wall conduit, downstream into the front interior space, and into the blower, then upstream from the blower to the heat producing device.

18. A method of operating an exothermic device mounted within an interior of a housing having a multi-wall construction with an outer wall spaced apart from an inner wall and an air conduit in the space between the outer and inner walls, comprising:
operating a blower within the housing and drawing ambient air into a rear end of the housing, then downstream and forward through the air conduit between the outer and inner walls of the housing, then downstream to a front interior space of the housing, and then downstream to the blower, the blower mounted at a downstream rear end of the front interior space;
blowing directly or indirectly, the air from the front interior space into a hot zone of the interior of the housing, the hot zone thermally insulated from the front interior space, and downstream into the exothermic device; and
emitting an exhaust from the exothermic device through an outlet of the housing.

19. The method of claim 18, wherein an assembly of electronic components are mounted in the housing interior in a component zone separate and upstream from the heat producing device and keeping the electronic components cool by drawing the ambient air over the electronic components with the blower.

20. The method of claim 19, comprising flowing the intake air from the front interior space to a flow control zone having electronically controlled blowers therein, and blowing the air with the electronically controlled blowers to the exothermic device, while electronically controlling said blowers.

21. The method of claim 18, wherein the exterior of the housing is thermally insulated from the exothermic device by the flow of ambient air flowing through the air conduit.

22. The method of claim 18, comprising electrically connecting the exothermic device to a dwelling, producing electricity with the exothermic device, and maintaining the electrical connection to the dwelling while and the electricity producing components of the device are slid out from the interior of the housing for service or replacement.
